(19) United States
(12) Patent Application Publication
(10) Pub. No.: US 2015/0129569 A1
(43) Pub. Date: May 14, 2015

(54) PORTABLE WELDING WIRE FEEDER WITH ON-BOARD TOOL BOX

(71) Applicant: LINCOLN GLOBAL, INC., CITY OF INDUSTRY, CA (US)

(72) Inventor: VICTOR MILLER, JAMUL, CA (US)

(73) Assignee: LINCOLN GLOBAL, INC., CITY OF INDUSTRY, CA (US)

(21) Appl. No.: 14/174,918

(22) Filed: Feb. 7, 2014

Related U.S. Application Data
(60) Provisional application No. 61/903,102, filed on Nov. 12, 2013.

(51) Int. Cl. B23K 9/133

(52) U.S. Cl. CPC B23K 9/133
USPC 219/137.2

(57) ABSTRACT

A portable welding wire feeder including a plastic instrument case having a base and a lid which are injection molded; the lid defining an interior cavity and the base defining an interior base cavity, a chassis mounted in the base cavity and adapted to support a spool of weld wire, a wire feeder mounted within the base and adapted to feed wire from the spool to an exterior of the instrument case; and a tool box shaped to conform to the interior of the lid and reside therein.

This application claims priority to and the benefit of U.S. Provisional Patent Application 61/903,102, filed on Nov. 12, 2013.

### TECHNICAL FIELD

The present invention relates generally to welding wire feeders. More specifically, it relates to a portable welding wire feeder housed in an instrument case and a method of modifying an instrument case to house a welding wire feeder and an on-board tool box.

### BACKGROUND OF THE INVENTION

Housings for welding wire feeders are typically made from either metal or plastic. Non-portable wire feeders, for example, typically have metal housings made from sheet metal. The sheet metal is bent and punched to form a custom housing for each wire feeder model. These non-portable wire feeders are generally used indoors at a single location.

Portable wire feeders, on the other hand, typically have handles and are transported from location to location. Portable wire feeders are used outdoors where they are exposed to the elements. This is especially true in the ship building and construction industries. Plastic housings are ideally suited for this type of usage because they are impact and corrosion resistant. Plastic housings also act as an electrical insulator between the internal wire feeder components and the external working environment such as the metal on ships.

Plastic housings for welding wire feeders have typically been custom made using rotational molding techniques, although injection molding and compression molding have also been used. Rotational molding is desirable over injection and compression molding because of the lower tooling costs involved. Typical wire feeder sales volumes do not justify high tooling costs.

### SUMMARY OF THE INVENTION

The present invention generally provides a portable welding wire feeder including a plastic instrument case having a base and a lid which are injection molded; the lid defining an interior cavity and the base defining an interior base cavity, a chassis mounted in the base cavity and adapted to support a spool of weld wire, a wire feeder mounted within the base and adapted to feed wire from the spool to an exterior of the instrument case; and a tool box shaped to conform to the interior of the lid and reside therein.

### BRIEF DESCRIPTION OF THE DRAWINGS

FIG. 1 is a right side perspective view of a portable welding wire feeder with an on-board tool box shown in a closed position.

FIG. 2 is left side perspective view thereof.

FIG. 3 is front view thereof.

FIG. 4 is a top view thereof.

FIG. 5 is right side view thereof.

FIG. 6 is front perspective view similar to FIG. 1 with the tool box shown in an open position.

FIG. 7 is a left side perspective view thereof.

FIG. 8 is a front perspective view thereof.

FIG. 9 is a top perspective view thereof.

FIG. 10 is a right side view thereof.

FIG. 11 is an end elevational view of a portable welding wire feeder according to the invention shown with a controller hung on a bracket attached to the exterior of the portable welding wire feeder.

FIG. 12 is an exploded perspective view of the portable welding wire feeder according to the invention.

FIG. 13 is a front perspective view of a portable welding wire feeder according to an alternative embodiment of the invention.

FIG. 14 is a right side perspective view thereof.

FIG. 15 is a left side perspective view thereof.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### DETAILED DESCRIPTION

While the present invention will be illustrated with reference to a particular welding wire feeder having a particular configuration and particular features, the present invention is not limited to this configuration or to these features and other configurations and features can be used. Similarly, while the present invention will be illustrated with reference to a particular wire feeder housing and method for making the same, other wire feeder housings and other methods can be used.

As used herein, spatially orienting terms such as “above,” “below,” “upper,” “lower,” “inner,” “outer,” “right,” “left,” “vertical,” “horizontal,” “top,” “bottom,” “upward,” “downward,” “laterally,” “upstanding,” et cetera, can refer to respective positions of aspects as shown in or according to the orientation of the accompanying drawings. “Inward” is intended to be a direction generally toward the center of an object from a point remote to the object, and “outward” is intended to be a direction generally away from an internal point in the object toward a point remote to the object. Such terms are employed for purposes of clarity in describing the drawings, and should not be construed as exclusive, exhaustive, or otherwise limiting with regard to position, orientation, perspective, configuration, and so forth.

Generally, the present invention involves a portable welding wire feeder housed in an instrument case. The instrument case depicted is a commercially available instrument case, Pelican 1400, that is intended for use in a wide variety of applications, including many applications that are outside of the welding industry. It will be understood that a custom case may also be used according to the invention.

The instrument case is adapted to hold the various welding wire feeder components that make up the wire feeder. Interfaces are provided in the case to receive the various inputs, such as weld power, shielding gas and trigger control signals. Likewise, interfaces are also provided in the instrument case to allow various outputs such as the weld wire, weld power and shielding gas to be delivered to the arc.

The welding wire feeder is used with the instrument case closed in the preferred embodiment. Or in other words, the instrument case is not simply used as a carrying case or a storage case for the welding wire feeder. Rather, the instrument case functions as a housing for the welding wire feeder in this embodiment and the welding wire feeder is used while the instrument case remains closed. The wire feeder may, however, also be operated with the instrument case open.

The welding wire feeder is modular in one embodiment. The various wire feeder components are mounted to a chassis frame to form a single chassis in this embodiment. The chassis is mounted to the inside of the instrument case housing using conventional fasteners and can be removed easily as a single unit for servicing or repair purposes. In an alternative embodiment, some or all of the various wire feeder components are separately mounted to the inside of the case using their own fasteners.

Wire feeder component as used herein includes wire drive assemblies, spool supports, weld power delivery devices, gas valves, circuit boards, control panels, etc . . .

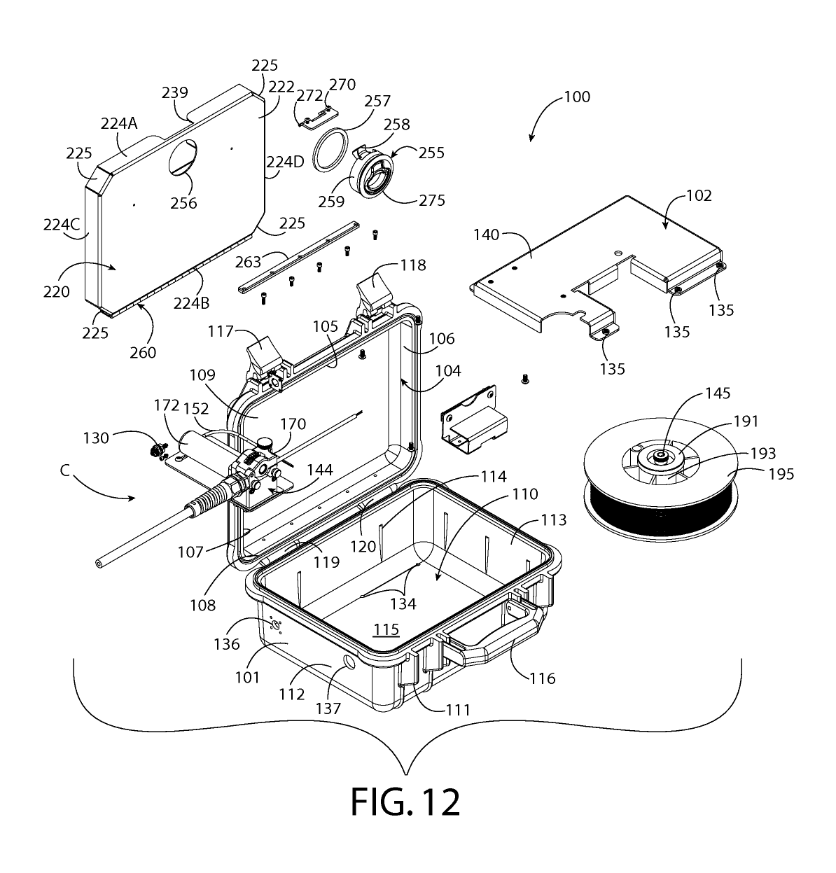

FIG. 12 shows an exploded view of one embodiment of the present invention. A portable welding wire feeder 100 generally includes an instrument case housing 101, a chassis 102 that mounts inside housing 101 and a tool box that mounts inside the housing 101. The chassis assembly is configured to support one or more wire feeder components C. According to one embodiment, the chassis supports the one or more wire components on one side of the instruments case with the tool box 220 filling the opposite side of the instrument case. Optionally, the tool box 220 may fill less than an entire side of the instrument case allowing wire feeder components to be supported on the same side of tool box 220.

Housing 101 is made from a commercially available instrument case. The particular instrument case used in this embodiment is case model no. 1400 manufactured and sold by Pelican Products of Torrance, Calif. This particular case is an injection molded case. In alternative embodiments, the case is manufactured using different techniques including compression molding or rotational molding.

Although a particular type and size of instrument case is used in this embodiment, the present invention is not limited to this particular model or size of case and other case models and sizes can be used. In alternative embodiments, for example, the case has different overall dimensions and different weights and/or is made using different molding techniques. The present invention is also not limited to instrument cases per se. Instrument case as used herein means an instrument case, toolbox, briefcase, suitcase or other similar type of case that is commercially available off-the-shelf for use in a wide variety of applications and/or industries.

Housing 101 as shown in detail in FIG. 12 includes a three dimensional (e.g. not flat) cover or lid 104 having four sidewalls 105-108 and a top wall 109, a three dimensional base 110 having four sidewalls 111-114 and a bottom wall 115, a handle 116 hingedly attached to base 110, a pair of latches 117-118 each of which is hingedly attached to cover 104 and a pair of integrally molded hinges 119-120. The various components of housing 101, including cover 104, base 110, handle 116, latches 117-118, and hinges 119-120 are all injection molded parts in this embodiment. In alternative embodiments, some or all of these parts are rotationally molded, compression molded or made of metal or some other suitable material.

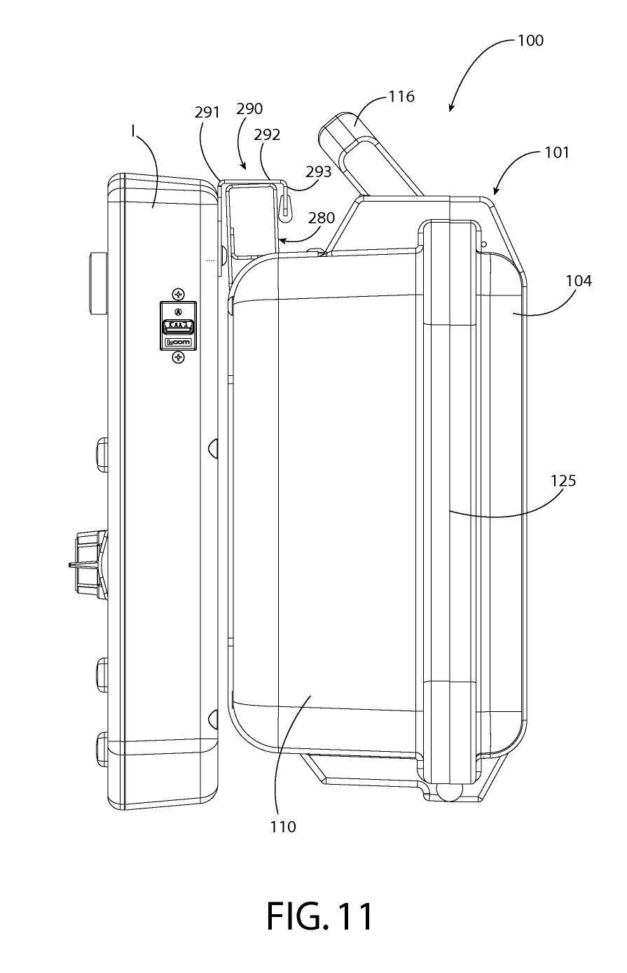

Cover 104 and base 110 mate along a mating seam 125 (FIG. 11) when instrument case housing 101 is closed. Mating seam 125 includes an O-ring seal and is airtight and watertight in this embodiment. Mating seam 125 is airtight and watertight in this embodiment not only because of its O-ring seal, but also in part because cover 104 and base 110 are rugged, reinforced and three dimensional in shape. It is not necessary for the invention, however, that mating seam 125 be airtight or watertight and in other embodiments mating seam 125 is neither airtight nor watertight.

Handle 116 and latches 117-118 are each hingedly attached to the instrument case housing 101 using plastic or metal hinge pins. Hinges 119 and 120 are integrally molded as part of cover 104 and base 110 and the two halves of each hinge are connected together with a plastic or metal hinge pin. Reinforcement ribs 126 are integrally molded into top wall 109, bottom wall 115, and into sidewalls 106, 108, 112, and 114 of instrument case housing 101 (see FIG. 7). These ribs add extra strength to housing 101.

Several interfaces have been added to the instrument case to adapt it into housing 101. The term interface as used herein means any hole, slot or other opening (including openings that are filled with adaptors or connectors), regardless of shape, or any adaptor or connector, added to an instrument case to allow various welding inputs to be supplied to the wire feeder when the instrument case is closed (e.g welding input interfaces) and/or to allow various welding outputs to be provided from the wire feeder when the instrument case is closed (e.g welding output interfaces). Interface openings that are added to an instrument case are typically made using machining or drilling operations, however other methods can be used including cutting, sawing, punching or stamping. Welding inputs received by a wire feeder and welding outputs provided by a wire feeder can include, but are not limited to, weld power, ac power, control signals, feedback signals, sense signals, weld wire and shielding gas.

A control interface 130 has been added to front sidewall 112 of base 110 in this embodiment. In the embodiment shown, control interface 130 includes a connection that provides power and control signals to the wire feeder. In other embodiments, these functions may be provided on separate interfaces. A wire feeder interface 132 has similarly been added to sidewall 112 and base 110. These interfaces may be added to the case at different locations in other embodiments. Likewise, the present invention is not limited to only these particular interfaces or this particular combination of interfaces and other interfaces and/or combinations can be added.

In addition to the interfaces described above, several holes 134 have also been added to bottom wall 115 of base 110. Six of these holes correspond to holes 135 in chassis 102 and are used as mounting holes to secure chassis 102 into housing 101 in the preferred embodiment. Holes 136-137 are respectively provided in sidewall 112 to mount the control interface 130 and wire feeder interface 132. Additional holes may be provided for drainage or to provide ventilation.

Chassis 102 may be any framework on which one or more wire feeder components are mounted including but not limited to the bend sheet form shown. The wire feeder components may be mounted to chassis 102 outside of the housing 101 and the entire chassis with components mounted thereon may be installed in, and mounted to, housing 101 as a single unit. Alternatively, the components may be mounted to the chassis after it is mounted within housing 101. The particular wire feeder components mounted to chassis frame 140 in this embodiment include a wire feeder 144 and a spool support 145. In the example shown, a spool is mounted on spool support 145 which is simply a bolt that is attached to chassis 102.

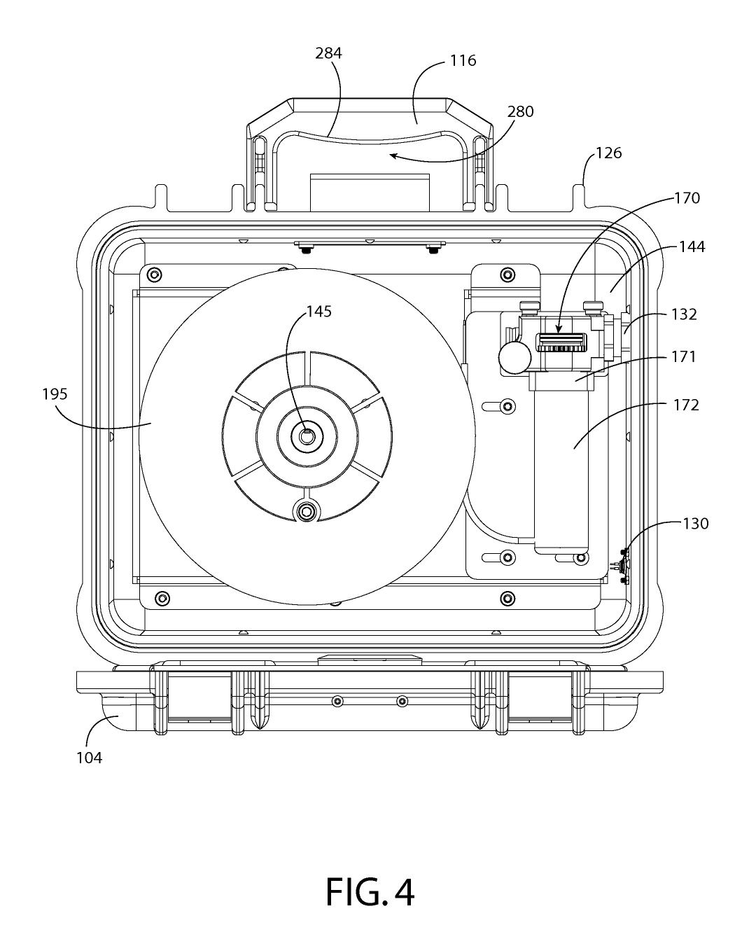

Wire feeder 144 as shown in detail in FIG. 4 includes a drive head 170, a feed motor 171 and a motor housing 172. Wire feeder 144 is mounted to chassis frame 140 using threaded fasteners. It will be appreciated that other fasteners may be used to mount wire feeder 144 including but not limited to welds, adhesives, bolts, rivots, pins, latches, clips, and the like.

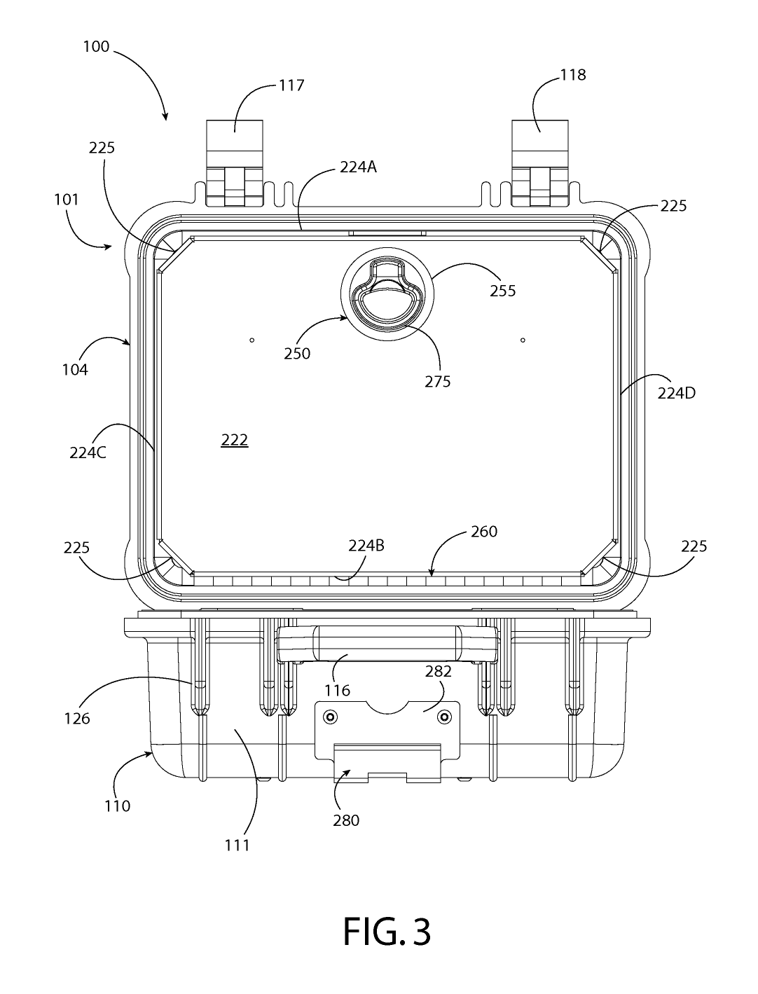

Wire spool support 145 as shown in FIG. 3 supports a spool 195 of weld wire having spool hub 193 and may be held in place by hub nut 191 or other fastener. The spool of weld wire 195 mounted on spool support 145 provides the weld wire to wire drive assembly 144 and is accessible to the operator with instrument case housing 101 open (e.g. cover 104 is open).

Spool support 145 is mounted on chassis 102, which in turn, is mounted to housing 101. Chassis 102 may be spaced from the interior surface of housing. For example rubber washers and screws may be used to mount the chassis 102 to housing 101. Although screws and shoulder washers are used in this embodiment to mount chassis 102 into housing 101, the present invention is not limited to these type of fasteners. In other embodiments, for example, bolts, nuts, conventional washers, glue, adhesive pads, rivets or velcro pads, or any combination of these, are used to mount chassis 102 to housing 101. Likewise, in other embodiments, chassis 102 is mounted to housing 101 at more or less than four locations.

With chassis 102 mounted in housing 101, the various components C on chassis 102 are automatically aligned with the interfaces that are provided in housing 101.

In alternative embodiments, one or more of the interface openings are filled with an adaptor or connector. For example, in one embodiment, the control interface 130 opening is provided with either a male or female connector and motor power cable 152 is internally connected to the connector. A weld cable from a welding power supply having a mating connector on its end is then connected externally to the connector to supply weld power to wire feeder 100.

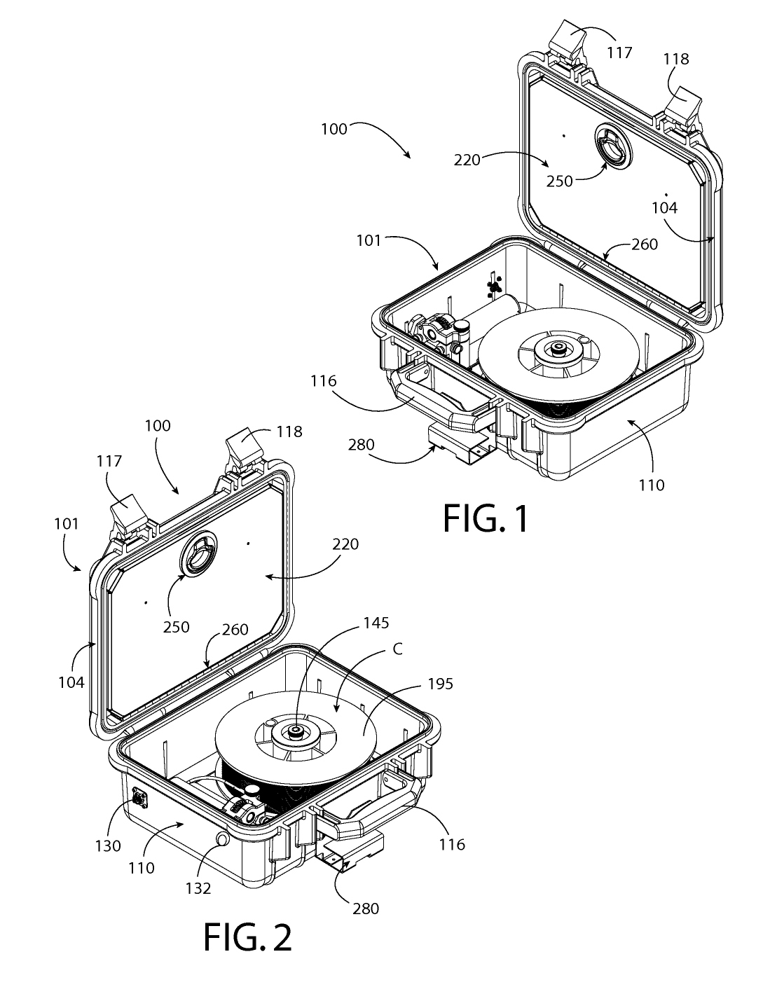

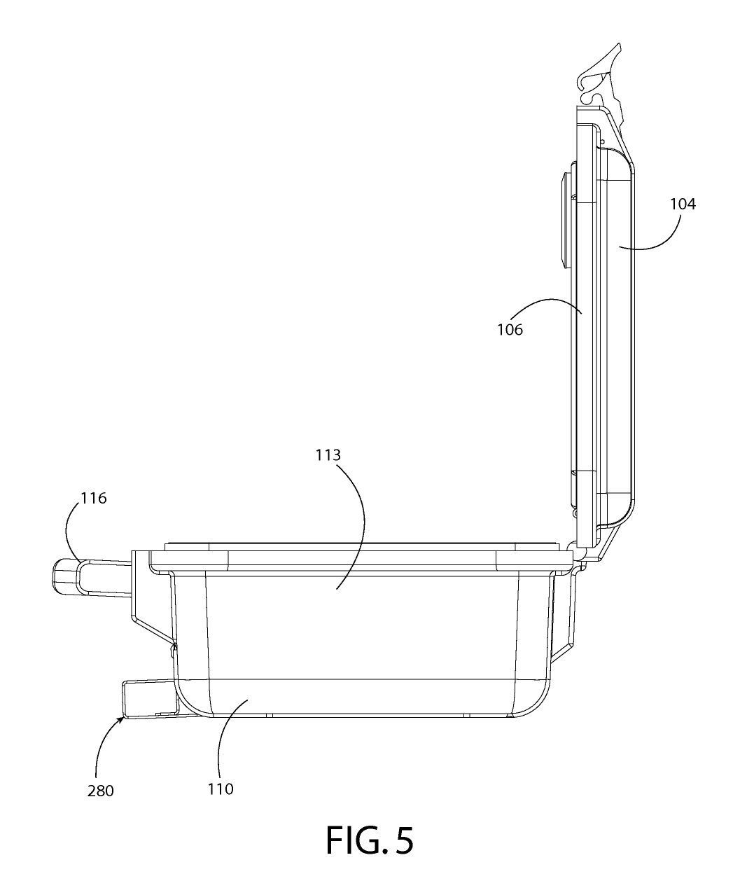

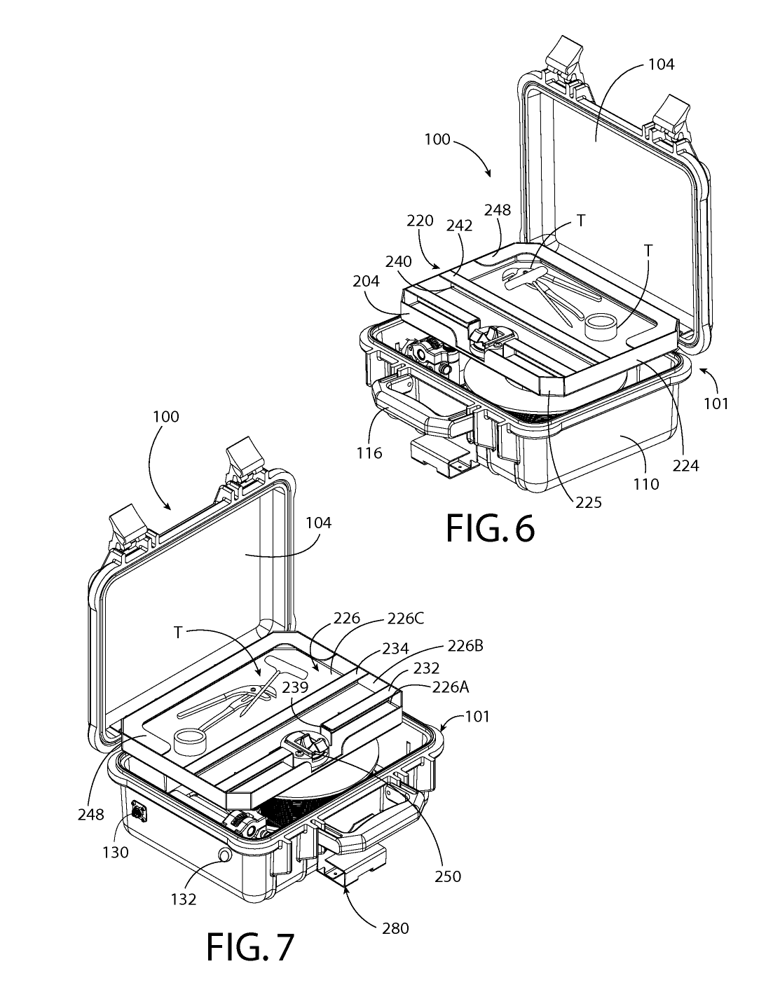

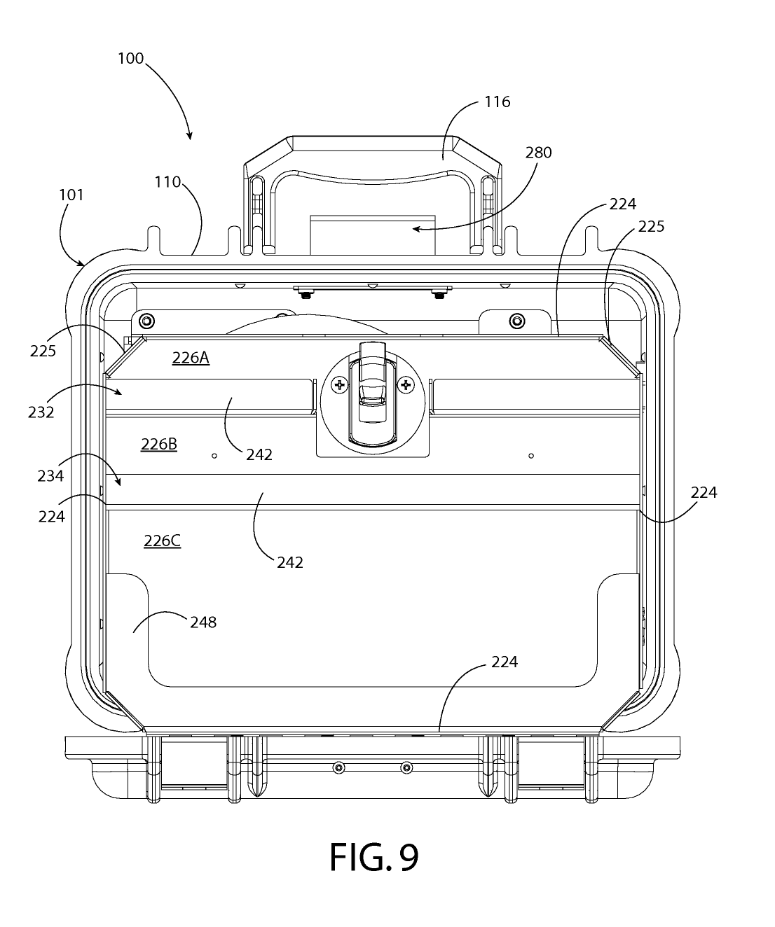

According to another aspect of the invention, instrument case 100 is modified to include an imbedded tool box, generally indicated by the number 220. Tool box 220 includes a base 222, one or more upstanding side walls 224 forming a tray-like compartment 226 sized to fit within the cavity defined by the top half of instrument case. In the example shown, sidewall 224 includes four sidewalls a top 224A, bottom 224B, left 224C, and right 224D joined by four angular corner segments 225 to conform to the rounded corners of the instrument case lid. The compartment may be divided into individual spaces or subcompartments 225A-C by one or more dividers 230. Alternatively, an insert may be placed in the compartment to provided divided spaces within the compartment. For example, it may be desirable to define subcompartments for different types of tools or to store consumables used in the welding process. In the example shown, a first divider 232 is provided near the upper portion 228 of compartment 226 to provide a thin compartment 226A for consumables, such as welding electrodes. A second divider 234 may be provided below first divider 232 to define a second subcompartment below first subcompartment 226B and a third subcompartment 226C between second divider 234 and the bottom wall 224D of tool box 220. The second divider 234 is located just above the center of tool box 220 forming a second subcompartment just below first subcompartment. In the example shown, first and second dividers are located in the upper half of the tool box such that the third subcompartment comprises the remaining half of the tool box, and may be used to hold larger items. For example, the lower half of tool box may hold tools T including but not limited to pliers, cutters, t-handled wrenches and the like. Dividers 232 and 234 may be of any shape of configuration. In the example shown, dividers 232 and 234 may have an L-shaped cross section to form a shelf 240 extending outward from the base 222 with an upturned lip or edge 242. Dividers 232, 234 may be attached to tool box 220 in any known manner including but not limited to a weld, a fastener, an adhesive, clips, brackets or the like. The dividers and walls of tool box 220 may all have a depth less than or equal to the depth of the lid to allow the tool box to fit within the interior cavity defined by the lid of the instrument case. A lower lip 246 may be provided at the bottom of tool box 220 to help organize or hold object within the bottom of compartment 216. In the embodiment depicted in FIGS. 1-12, first divider 232 is split to form a central gap 239 to accommodate a securement assembly 250 described more completely below.

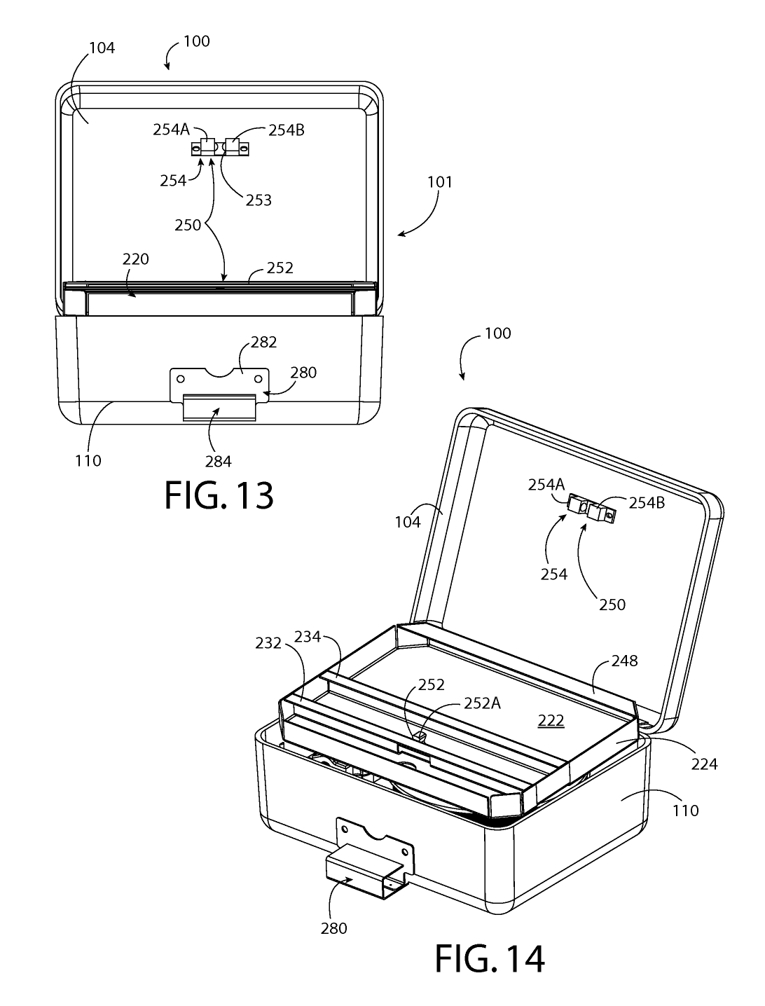

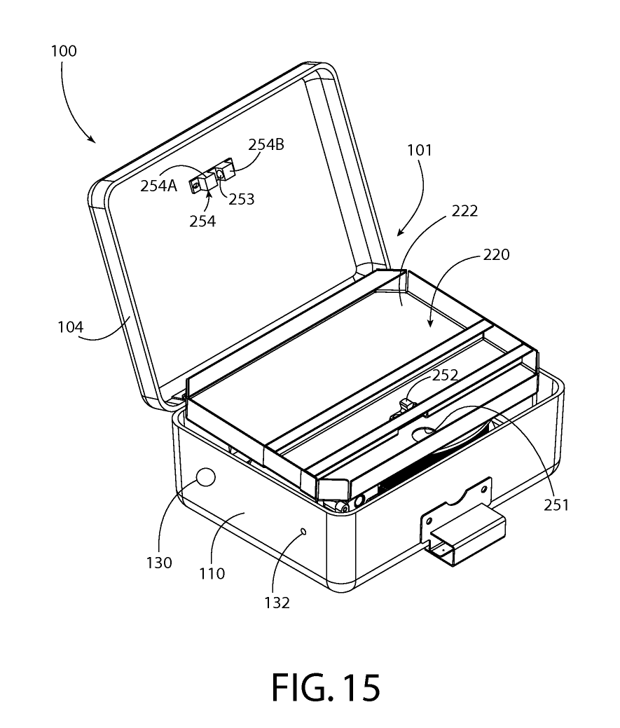

According to one embodiment of the invention, tool box 220 is press fit into lid 104. A securement assembly 250 may be provided to hold tool box 220 within lid 104. Securement assembly 250 provides releasable attachment of the tool box 220 to the lid and may include a releasable fastener including but not limited to a clip, a latch, a catch, one or more snap fasteners, a hook and loop fastener, a magnet, a threaded fastener, a post and cotter pin, and the like. In the embodiment shown in FIGS. 13-15, a catch 252 may be mounted on an interior surface of tool box 220. In the example shown, catch 252 extends outward from base 222 just below first divider 232. A catch receiver 254 is mounted on the lid to engage catch when the tool box 220 is inserted into the lid. Catch and receiver may be any type of catch and receiver including commercially available assemblies such as the ball detent assembly shown. Receiver 254 includes a pair of protruding detent 254A-B holders mounted on a plate having a pair of laterally outward extending tabs that are secured to lid by fasteners. The detent holders are spaced from each other to define a central gap into which the ball detents partially protrude. Catch includes a contoured post that is wider at its outermost extremity 252A. The detents 253 retract to permit passage of the wide end of the post and extend behind the wide end of the post to hold the tool box 220 in lid. Since some force may be required to remove the tool box 220 from the securement assembly, base 222 may be provided with a handle 251 to facilitate removal of the tool box 220. Handle 251 may include any graspable surface including but not limited to an opening in the base 222, as shown, a protruding surface, or separately attached member. Use of the opening in the base 222 prevents the tool box 220 from protruding into the remainder of the instrument case 100 maximizing the useful space in the base of the housing 101.

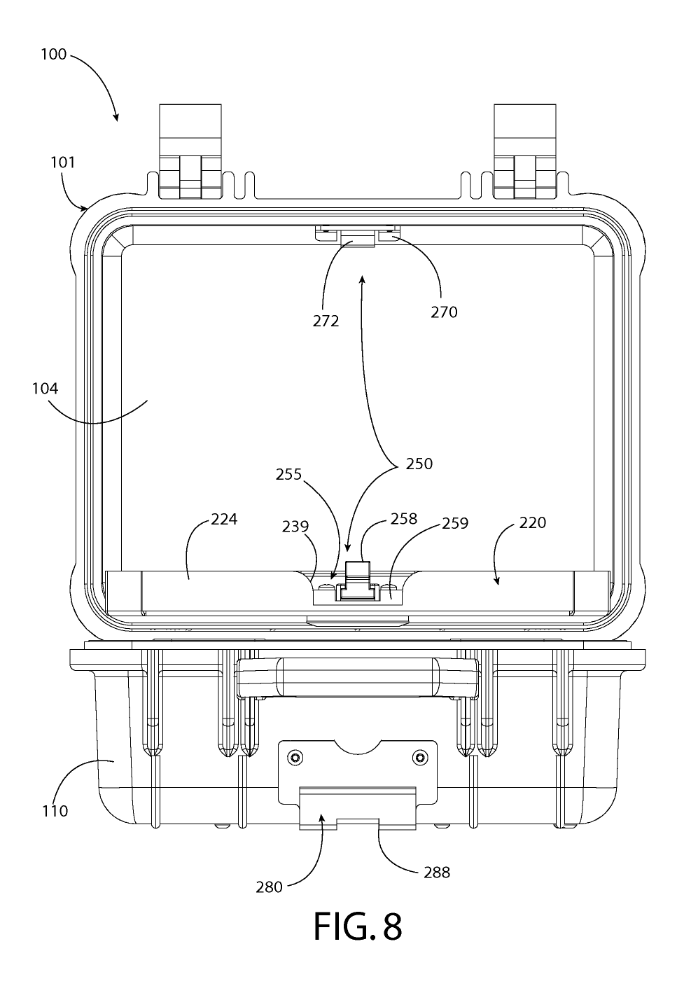

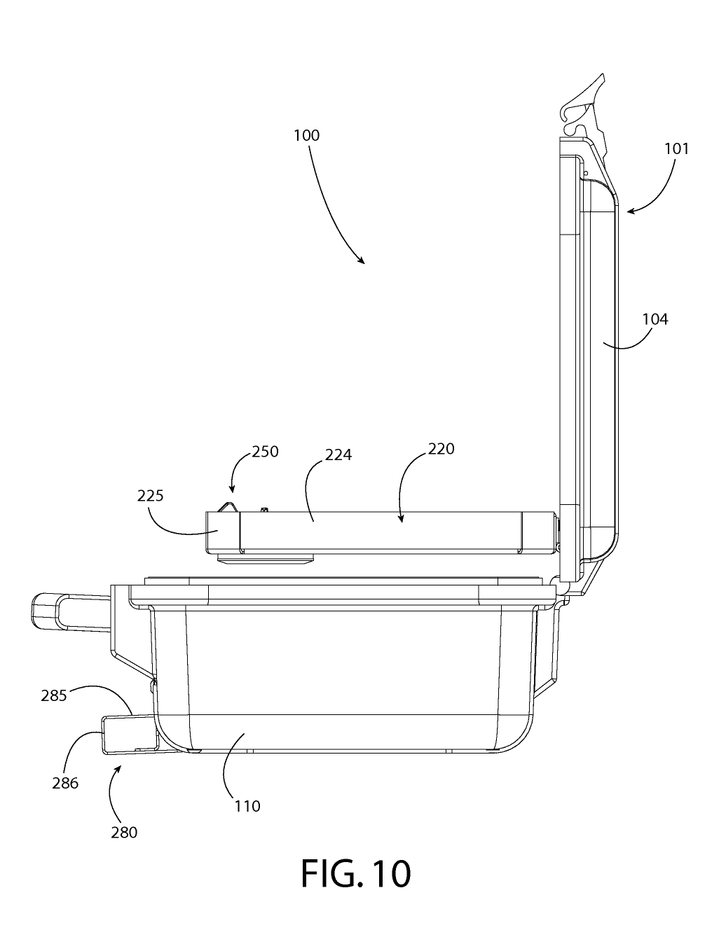

According to another embodiment best shown in FIGS. 8, 9 and 12, securement assembly 250 includes a latch and catch assembly that interact to secure the tool box 220 within the lid 104 as describe more completely below. In this example, tool box 220 is mounted within lid 104 on a hinge, generally indicated by the number 260. To accommodate hinge 260, a slot 262 (FIG. 8A) is formed in lid 104 to receive at least a portion of one flap 264 of hinge 260. The opposite flap is attached to the bottom segment 224D of tool box 220 to allow tool box slot 262 may also be reinforced with a hinge plate 263 (FIG. 12) to pivot outward from lid 104. As best shown in FIG. 12, securement assembly 250 may include a latch assembly generally indicated at 255 that is received within an opening 256 formed in the base 222 of tool box 220. Latch assembly 255 may include a cylindrical body that is heated within opening 256 and secured therein by a lock ring 257. Latch assembly includes a flexible latch 258 that extends from a top portion of cylindrical housing 259 to engage a catch 270 that is mounted to the upper wall 105 of lid 104. Catch 270 may simply be a plate having a downwardly dependent surface that engages the latch member 258 to initially force the latch 258 downward until is passes the catch plate causing it to retract to its initial position and provide a positive stop against the back 272 of catch 270. As shown, cylindrical body 259 may house a retractable handle 275 that may be used to manually retract latch 258 and disengage the securement assembly 250 to pivot the tool box 220 downward to the position shown in FIG. 10.

In accordance with another aspect of the invention, a hanger assembly, generally indicated by the number 280, is attached to an exterior surface of the instrument case 101. Hanger 280 generally provides a location to hang tools, controllers, or other implements on the exterior of the case 101. In the example shown, hanger 280 includes a L-shaped bracket having a base 282 that is fastened to the instrument case with an upstanding leg 284 on which an implement I may be mounted. Leg 284 may be shaped to conform to the clip or other means provided on the implement I to facilitate attachment of the implement I to the instrument case 101. In the example show, leg 284 has a U-shaped cross section formed by a first wall 285 and a second wall 286 joined at their upper ends by a cross member 288. An opening may be defined centrally within the first wall 285 and cross piece 288 to receive a protrusion on the implement clip to prevent the implement from sliding on leg 284. As best shown in FIG. 11 in the particular example shown, a clip 290 is provided on implement I. The clip 290 may include a first wall 291 that attaches to the implement I, a cross piece 292 that extends outward from first wall 291 and a downwardly turned lip 293 defining a somewhat U-shaped channel that fits over hanger 280 as shown.

Although the subject innovation has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (e.g., enclosures, sides, components, assemblies, etc.), the terms (including a reference to a “means”) used to describe such elements are intended to correspond, unless otherwise indicated, to any element which performs the specified function of the described element (e.g., that is functionally equivalent), even though not structurally equivalent to the disclosed structure which performs the function in the herein illustrated exemplary embodiment or embodiments of the innovation. In addition, while a particular feature of the innovation may have been described above with respect to only one or more of several illustrated embodiments, such feature may be combined with one or more other features of the other embodiments, as may be desired and advantageous for any given or particular application.

Although certain embodiments have been shown and described, it is understood that equivalents and modifications falling within the scope of the appended claims will occur to others who are skilled in the art upon the reading and understanding of this specification.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

1. A portable welding wire feeder comprising: a plastic instrument case having a base and a lid which are injection molded; the lid defining an interior cavity and the base defining an interior base cavity, a chassis mounted in the base cavity and adapted to support a spool of weld wire, a wire feeder mounted within the base and adapted to feed wire from the spool to an exterior of the instrument case; and a tool box shaped to conform to the interior of the lid and reside therein.

2. The portable welding wire feeder of claim 1 further comprising a securement assembly at least partially supported on the lid and adapted to selectively hold the tool box within the lid.

3. The portable welding wire feeder of claim 2, wherein the securement assembly includes a post supported on the tool box and a receiver supported on the lid, the receiver including a pair of spaced detents adapted to engage the post when the tool box is inserted within the lid.

4. The portable welding wire feeder of claim 2, wherein the securement assembly includes a latch mounted on the tool box and engageable with a catch mounted within the lid.

5. The portable welding wire feeder of claim 4, wherein the tool box is pivotally attached to the bottom of the lid; and wherein the latch is mounted on an upper wall of the tool box and wherein the catch is mounted on an upper wall of the lid.

6. The portable welding wire feeder of claim 1, wherein the tool box includes a base having an upper wall and a bottom wall and a pair of sidewalls extending outward therefrom to form a tray adapted to fit within the interior cavity of the lid.

7. The portable welding wire feeder of claim 6, wherein the upper wall and bottom wall are joined to the pair of sidewalls by angled corners.

8. The portable welding wire feeder of claim 1 wherein the tool box includes at least one divider forming subcompartments within the tool box.

9. The portable welding wire feeder of claim 1, wherein the tool box includes an upper wall, a bottom wall, and a pair of sidewalls; a first divider extending from one sidewall to the other sidewall to form a shelf within the tool box.

10. The portable welding wire feeder of claim 1, wherein the divider has an L-shaped cross section with a first leg extending outward from the base to form the shelf and an upturned second leg, wherein the second leg lies within a plane defined by the walls of the tool box.

11. The portable welding wire feeder of claim 9 further comprising a second divider spaced from the first divider, wherein the first divider and the second divider are both located in an upper half of the tool box.

12. The portable welding wire feeder of claim 1, wherein a slot is formed in a lower portion of the lid adjacent to a bottom wall of the interior cavity of the lid, and a hinge mounted within the slot and attached to the tool box to pivotally connect the tool box to the lid.

13. The portable welding wire feeder of claim 12 further comprising a securement assembly at least partially supported on the lid engageable with the tool box to selectively secure the tool box within the lid.

14. The portable welding wire feeder of claim 1 further comprising a hanger attached to an exterior of the instrument case, the hanger including a

15. A portable welding wire feeder comprising: a plastic instrument case having a base and a lid; the lid defining an interior cavity and the base defining an interior base cavity, a chassis mounted in the base cavity and adapted to support a spool of weld wire, a wire feeder mounted within the base and adapted to feed wire from the spool to an exterior of the instrument case; and a tool box shaped to conform to the interior of the lid and reside therein; wherein the tool box is pivotally mounted within the lid and selectively secured within the lid by a securement assembly.

16. The portable welding wire feeder of claim 15, wherein the tool box is pivotally mounted within the lid by a hinge attached to a bottom wall of the lid and a bottom wall of the tool box.

17. The portable welding wire feeder of claim 15, wherein the securement assembly includes a latch mounted on the tool box and engageable with a catch mounted within the lid.

18. The portable welding wire feeder of claim 15, wherein the securement assembly includes a post supported on the tool box and a receiver supported on the lid, the receiver including a pair of spaced detents adapted to engage the post when the tool box is inserted within the lid.

19. The portable welding wire feeder of claim 15, wherein the tool box includes a base having at least one upstanding wall that defines a tray like compartment.

20. The portable welding wire feeder of claim 19, wherein the at least one upstanding wall includes angular corner segments joining a top wall, a bottom wall, and a pair of sidewalls defining a generally rectangular compartment.
